(19) United States
(12) Patent Application Publication
(10) Pub. No.: US 2010/0167904 A1
(43) Pub. Date: Jul. 1, 2010

(54) POLARIZED GLASS AND METHOD FOR MANUFACTURING THE POLARIZED GLASS

(75) Inventors: Masahiro ICHIMURA, Niigata (JP); Shozo MORIMOTO, Niigata (JP); Yohsuke KANAYA, Niigata (JP)

Correspondence Address: Masao Yoshimura, 333 W. El Camino Real, Suite 380, Sunnyvale, CA, 94087, US

(73) Assignee: POLATECHNO CO., LTD., Niigata (JP)

(21) Appl. No.: 12/491,930

(22) Filed: Jun. 25, 2009

Related U.S. Application Data
(63) Continuation of application No. PCT/JP2007/073522, filed on Dec. 5, 2007.

(30) Foreign Application Priority Data
Dec. 26, 2006 (JP) 2006-350621

(51) Int. Cl. C03C 14/00; C03C 15/00

(52) U.S. Cl. 501/32; 65/30.13

(57) ABSTRACT

Provided is a method for manufacturing polarized glass, comprising forming a glass preform by melting glass that includes metal ions and halogen ions and then depositing metal halide particles in the glass in which the metal ions and the halogen ions are dispersed; forming a glass sheet containing extended metal halide particles that are obtained by extending the metal halide particles by performing thermal drawing on the glass preform at a prescribed temperature; annealing by heating the glass sheet to a temperature that is no greater than a transformation temperature of the glass and no less than a distortion temperature of the glass; and reducing the extended metal halide particles in the glass sheet that has undergone said annealing into extended metal particles. The glass preform formed in said forming a glass preform has a haze between 0.3% and 1.3% with respect to light in a wavelength region passed by a G filter.

### BACKGROUND

1. Technical Field

The present invention relates to polarized glass and a method for manufacturing the same. In particular, the present invention relates to polarized glass obtained by extending a glass preform that includes metal halide, and a method for manufacturing the same.

The present patent application claims priority based on a Japanese patent application, JP 2006-350621 filed on Dec. 12, 2006, the contents of which are incorporated herein by reference.

2. Related Art

Polarizers that linearly polarize light are used in many types of video equipment such as LCD televisions and LCD projectors, as well as in the field of optical communication. Types of polarizers include crystal birefringence polarizers, inorganic multilayered thin film polarizers, absorptive polarizers, and the like made from organic or inorganic materials. The majority of polarizers used in video equipment, however, are organic absorptive polarizers.

Organic absorptive polarizers absorb unnecessary polarized components so that there is less stray light, and can be formed easily in a thin board, thereby allowing for a high degree of freedom when being incorporated into the design of a device. However, these polarizers have a low endurance for light and heat, and so, particularly in video equipment with a large optical output, there is a problem that the optical characteristics such as transmittance and contrast ratio degrade over time. This degradation occurs because, when the organic absorptive polarizers absorb light in the visible light wavelength spectrum of 400 nm to 800 nm (referred to hereinafter as the “visible region”), especially green light in a band from 500 nm to 600 nm (referred to hereinafter as the “green region”), the organic dye contained in the organic absorptive polarizers is dispersed.

On the other hand, inorganic absorptive polarizers, exemplified here as polarized glass, have superior heat resistance and have optical capabilities that do not easily decay over time due to the light absorption, as organic absorptive polarizers do. Therefore these inorganic absorptive polarizers are expected to be suitable for use in video equipment. A glass polarizer is known as an inorganic absorptive polarizer having relatively good optical characteristics in the visible region, as in, for example, Japanese Patent Application Publication No. 8-50205.

The glass polarizer disclosed above, however, cannot be said to have optical characteristics in the green region of the visible region that are desired for practical use, e.g. characteristics such as a TE wave transmission factor above 75% and a contrast ratio of 1000:1. Therefore, an inorganic absorptive polarizer with superior optical characteristics in the green region is desired.

### SUMMARY

Therefore, it is an object of an aspect of the innovations herein to provide a test apparatus and a test method, which are capable of overcoming the above drawbacks accompanying the related art. The above and other objects can be achieved by combinations described in the independent claims. The dependent claims define further advantageous and exemplary combinations of the innovations herein.

According to a first aspect of the present invention, provided is a method for manufacturing polarized glass, comprising forming a glass preform by melting glass that includes metal ions and halogen ions and then depositing metal halide particles in the glass in which the metal ions and the halogen ions are dispersed; forming a glass sheet containing extended metal halide particles that are obtained by extending the metal halide particles by performing thermal drawing on the glass preform at a prescribed temperature; annealing by heating the glass sheet to a temperature that is no greater than a transformation temperature of the glass and no less than a distortion temperature of the glass; and reducing the extended metal halide particles in the glass sheet that has undergone said annealing into extended metal particles. The glass preform formed in said forming a glass preform has a haze between 0.3% and 1.3% with respect to light in a wavelength region passed by a G filter.

Desirably, the metal halide particles deposited during said forming a glass preform have diameters between 10 nm and 30 nm.

Desirably, during said forming a glass preform, the glass is held for at least two hours in a temperature range that is ±30 degrees Celsius from a deformation temperature the glass, and is then held for a prescribed time no longer than five hours in a temperature range between a temperature 20 degrees Celsius lower than a softening temperature of the glass and a temperature 30 degrees Celsius higher than the softening temperature of the glass.

Desirably, during said reducing, the glass sheet is held for a prescribed time between 30 minutes and 4 hours at a temperature that is 20 degrees Celsius or more lower than a transition temperature of the glass.

Desirably, during said reducing, the extended metal particles reduced from the extended metal halide particles in the glass sheet include silver.

According to a first aspect of the present invention, provided is polarized glass manufactured via a method comprising forming a glass preform by melting glass that includes metal ions and halogen ions and then depositing metal halide particles in the glass in which the metal ions and the halogen ions are dispersed; forming a glass sheet containing extended metal halide particles that are obtained by extending the metal halide particles by performing thermal drawing on the glass preform at a prescribed temperature; annealing by heating the glass sheet to a temperature that is no greater than a transformation temperature of the glass and no less than a distortion temperature of the glass; and reducing the extended metal halide particles in the glass sheet that has undergone said annealing into extended metal particles. The glass preform formed in said forming a glass preform has a haze between 0.3% and 1.3% with respect to light in a wavelength region passed by a G filter.

Desirably, the haze with respect to light in a wavelength region passed by the G filter is between 1% and 3%.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

As made clear from the above, the present invention enables manufacturing of polarized glass having favorable optical characteristics in the visible region by forming a glass preform with a haze between 0.3% and 1.3% with respect to light in a wavelength region passed by a G filter.

### BRIEF DESCRIPTION OF THE DRAWINGS

FIG. 1 is a schematic view showing the configuration of an extending apparatus 100 used in the extension.

FIG. 2 is a schematic view showing the configuration of a stretching means 40 in the extending apparatus 100.

FIG. 3 is a schematic view showing the state of metal halide particles 30 extended in the glass preform 11 when the glass preform 11 undergoes the extension.

FIG. 4 is a graph showing a relationship between the transmission factor and wavelength region when non-polarized visible light passes through glass preforms 11 having various types of haze.

FIG. 5 is a graph showing a relationship between the haze of the glass preform 11 and the contrast ratio of the polarized glass formed from the glass preform 11.

FIG. 6 is a graph showing the relationship between the haze of the glass preform 11 and the average diameter of the metal halide particles 30 in the glass preform 11.

FIG. 7 is a graph showing the relationship between the haze of the glass preform 11 and the tensile stress exerted during the extension on the polarized glass formed from the glass preform 11.

FIG. 8 shows transmission factor characteristics of polarized glass obtained from the first embodiment.

FIG. 9 shows transmission factor characteristics of polarized glass obtained from Comparative Example 1.

FIG. 10 shows transmission factor characteristics of polarized glass obtained from Comparative Example 2.

FIG. 11 shows transmission factor characteristics of polarized glass obtained from Comparative Example 3.

FIG. 12 shows exemplary transmission factor characteristics for the wavelengths of a G filter.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

The method for manufacturing polarized glass according to the present embodiment (referred to hereinafter as the “present manufacturing”) involves (i) a preparation step of preparing a glass base material that contains at least metal ions and halogen ions, (ii) a deposition step of forming a glass preform by depositing metal halide particles in the glass base material in which the metal ions and halogen ions are dispersed, (iii) an extension step of forming a glass sheet that contains extended metal halide particles, which result from the metal halide particles being extended by thermally drawing, with a prescribed temperature, the glass preform formed by the above deposition, (iv) an annealing step of performing annealing by heating the glass sheet formed by the above extending to a temperature that is no greater than the transition temperature of glass and no less than the distortion temperature of glass, and (v) a reduction step of reducing the extended metal halide particles in the glass sheet resulting from the above annealing into extended metal particles.

The preparation step may involve melt-blending glass raw material and metal halide raw material, and then solidifying this mixture to form the glass base material. In this case, it is desirable that aluminum borosilicate glass be used as the glass raw material and silver halides such as silver chloride (AgCl), silver bromide (AgBo), and silver iodide (AgI) be used as the metal halide raw material.

During the preparation step, the glass base material may be formed by performing an ion-exchange between the sodium in the glass raw material and other metal ions and injecting these other metal ions. One example of such an ion exchange is a technique of immersing the glass base material in molten salt. The salt used for this immersion may be a suitable mixed salt that contains the injected metal ions. For example, if silver ions are injected, a mixture of silver nitrate and alkali metal nitrate is desirably used. Another example of the ion-exchange is a technique of evaporating the injected metal in the glass base material and applying a voltage to the resulting evaporated film.

In the deposition step, after melting the glass base material containing the metal ions and the halogen ions, the glass preform is formed by depositing the metal ions and halogen ions dispersed in the glass base material with a prescribed particle diameter. More specifically, after melting the glass base material in which the metal ions and halogen ions are dispersed, the melted glass base material is formed into the shape of a board or a block. Then, the thus-formed glass is heated to deposit the metal halide particles. During this deposition, the glass base material is held for at least two hours at a temperature within a range of ±30 degrees Celsius from the deformation temperature of glass, and is then held for a specified time no longer than five hours between a temperature 20 degrees Celsius below the softening point of glass and a temperature 30 degrees higher than the softening point of glass. This heating causes the metal halide particles to be deposited in the glass formed as described above. Here, the deposited metal halide particles can be thought of as mixed crystals of AgCl, AgBr, and AgClBr. Next, the heated glass is carved to a narrow strip to form the glass preform.

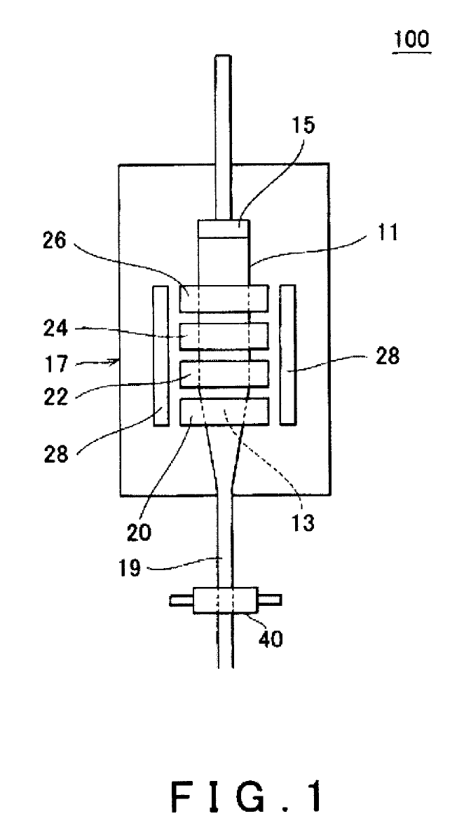

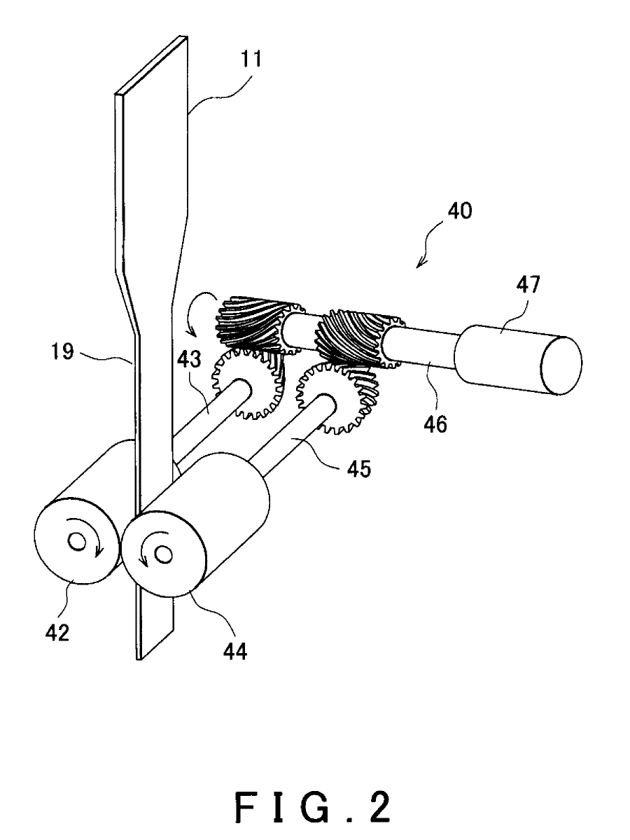

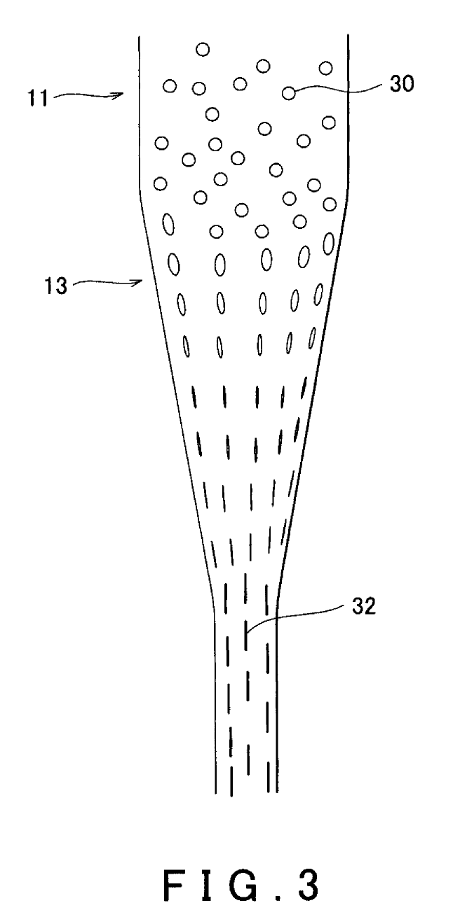

The extension step involves thermally drawing the glass preform, into which the metal halide particles were deposited in the deposition step. FIG. 1 is a schematic view showing the configuration of an extending apparatus 100 used in the extension step. FIG. 2 is a schematic view showing the configuration of a stretching means 40 in the extending apparatus 100. FIG. 3 is a schematic view showing the state of metal halide particles 30 extended in the glass preform 11 when the glass preform 11 undergoes the extension step.

As shown in FIG. 1, the extending apparatus 100 includes (i) an electric furnace 17, (ii) a glass support 15 that is disposed inside the electric furnace 17 and that has one longitudinal end of the glass preform 11 fixed thereto, (iii) a main heater 20, sub-heaters 22, 24, and 26, and side heaters 28 that are disposed inside the electric furnace 17, and (iv) the stretching means 40 that is disposed longitudinally relative to the glass preform 11 and below the various heaters. In the extension step, first, the glass preform 11 is heated by the main heater 20, the sub-heaters 22, 24, and 26, and the side heaters 28. Simultaneously with this heating, the glass support 15, to which is fixed the one longitudinal end of the glass preform 11, is slowly moved in a direction of the stretching means 40, and the other end of the glass preform 11 is pulled in the longitudinal direction by the stretching means 40. As a result, the glass preform 11 extends due to the force in the direction of the pulling.

During the heating in the extension step, (i) the main heater 20 heats the region in the center of the width of the extending section 13 from the narrow strip surface of the extending section 13 where compression occurs in the direction of the width, (ii) the side heaters 28 heat the sides of the extending section 13 from the sides of the narrow strip of the extending section 13, and (iii) the sub-heaters 22, 24, and 26 are arranged at prescribed intervals above the main heater 20 to provide heat.

The main heater 20 and the sub-heaters 22, 24, and 26 are wider than the glass preform 11. The output of each of the main heater 20, the sub-heaters 22, 24, and 26, and the side heaters 28 is controlled independently, so that the glass preform 11 and the metal halide particles 30 in the glass preform 11 can be heated with a temperature distribution suitable for the extending. The sub-heaters 22, 24, and 26 heat the top of the extending section 13 in stages.

As shown in FIG. 2, the stretching means 40 includes (i) a pair of rollers 42 and 44 that sandwich the front and back surfaces of the glass sheet 19, (ii) driven shafts 43 and 45 that are formed integrally with the rollers 42 and 44, respectively, (iii) a drive shaft 46 that mechanically causes the driven shafts 43 and 45 to rotate in synchronization, and (iv) a motor 47 that provides the drive shaft 46 with rotational drive. Torsion gears are formed on the driven shafts 43 and 45 with the same pitch as each other, and corresponding gears are formed on the drive shaft 46 to interlock with the gears of torsion gears formed on the driven shafts 43 and 45.

In the extension step, as shown in FIG. 3, the glass preform 11 and the metal halide particles 30 contained therein are stretched to form the glass sheet 19 containing the extended metal halide particles 32. The error in the thickness of the glass sheet 19 formed as described above can be smoothed to be less than ±50 μm, for example, by setting the most suitable conditions for the extension force or the like. In this case, a step of polishing the glass sheet 19 obtained from the annealing step, described further below, can be omitted, thereby achieving a lower cost than a process that includes a polishing step.

In the annealing step, the glass sheet 19 formed in the extension step is heated to a temperature that is no greater than the transition temperature of glass and no less than the distortion temperature of glass, and is then cooled. Here, the annealing step includes an operation of heating and cooling to mitigate residual stress (residual strain) occurring inside a solid material using thermal processing and cutting. In the present embodiment, the annealing step includes a heating and cooling operation to remove the residual strain from inside the glass sheet 19.

In the annealing step, the thermal property of the glass sheet 19 and the melting point of the extended metal halide particles 32 in the glass sheet 19 are near the deformation temperature of the glass sheet 19. Accordingly, the extended metal halide particles 32 in the glass sheet 19 can be considered to be melted in a temperature range no greater than the transition temperature of the glass sheet 19 and no less than the deformation temperature of the glass sheet 19. However, the glass sheet 19 itself maintains a rigid state, and so the extended metal halide particles 32 are held in the extended shape by the circumferential glass phase even when in the melted state.

If the glass sheet 19 is heated above the transition temperature, the glass becomes viscoelastic and the extended metal halide particles 32 in the glass sheet 19 return to the round state, lowering the aspect ratio. As a result, it is difficult to achieve desirable optical characteristics for the polarized glass, such as a decreased extinction ratio. On the other hand, if the glass sheet 19 is not heated beyond the deformation temperature, it is difficult to remove the residual strain in the glass sheet 19.

In the annealing step of the present embodiment, the glass sheet 19 is heated in an anneal oven to a temperature that is no greater than the transition temperature of glass and no less than the distortion temperature of glass, is held at this temperature for approximately two hours, and is then slowly cooled at a rate of one degree Celsius per minute until reaching a temperature below the deformation temperature and left to cool naturally in the anneal oven.

In the reduction step, the polarizing characteristics are applied to the glass sheet 19 to form the polarized glass by performing a reduction to reduce at least a portion of the extended metal halide particles 32 in the glass sheet 19 into extended metal particles. More specifically, by loading and heating the glass sheet 19 in a reduction furnace having a hydrogen atmosphere, for example, the metal ions in the extended metal halide particles 32 that are within a certain depth from the surfaces of the glass sheet 19 can be reduced. This depth can be controlled according to the reduction temperature, e.g. the atmospheric temperature in the reduction furnace, or the reduction time.

The polarized glass formed as a result of the reduction step contains the extended metal particles, which are obtained from the above reduction of the extended metal halide particles 32. These extended metal particles are shaped as ellipsoids, and are dispersed or oriented in the polarized glass. The shape and metallic characteristics of the extended metal particles are greatly affected by the polarization characteristics of the polarized glass. The following describes the relationship between the optical properties of certain metals and the polarization characteristics of the polarized glass that includes these metals.

The polarized glass utilizes the dichroism of the metal dispersed or oriented on the surface of the glass or inside the glass. Dichroism is a quality by which there is a difference between the spectral absorption coefficient with respect to linearly polarized light on an optical axis incident to the polarized glass and the spectral absorption coefficient with respect to linearly polarized light orthogonal to the above linearly polarized light. The difference between the spectral absorption coefficients differs depending on the type of metal. Therefore, it is suitable to use, for the polarized glass, metal that has a low absorption of one of the linear polarized lights, from among the linear polarized lights that are orthogonal to each other, and that has a greater absorption of the other linearly polarized light. Here, plasma resonance absorption of the metal greatly contributes to increasing the absorption. More specifically, in the energy indicating plasma resonance absorption, the majority of incident light is absorbed by the metal. Therefore, when the light incident to the polarized glass in which the prescribed metal is dispersed or oriented is light that in a wavelength for which this metal exhibits plasma resonance absorption, the transmission factor of the light decreases.

This plasma resonance absorption can be considered as being caused by interband transition in the metal. The plasma resonance absorption occurs regardless of whether the shape of the metal is spherical or ellipsoidal. The wavelength exhibiting plasma resonance absorption is a specified wavelength that does not change depending on a TE wave or a TM wave when the metal is spherical, and is a specified wavelength that differs for a TE wave and a TM wave when the metal is ellipsoidal. Here, the TE wave (S wave) is a wave in which the electric field fluctuates linearly with respect the longitudinal axis of the ellipsoidal metal, and the TM wave (P wave) is a wave in which the electric field fluctuates in parallel with respect to the longitudinal axis of the ellipsoidal metal.

When the metal is ellipsoidal, in the wavelength of the TM wave exhibiting plasma resonance absorption, an increase in the aspect ratio, which is the ratio between the long axis and the short axis of the ellipsoid, leads to the metal particles becoming long and thin, which causes a shift to the long wavelength side. On the other hand, in the wavelength of the TE wave exhibiting plasma resonance absorption, an increase in the aspect ratio leads to a shift to the short wavelength side from the waveform indicating the plasma resonance absorption when the aspect ratio is 1, but this shift is very small. Accordingly, spherical metal does not display dichroism, while ellipsoidal metal does display dichroism.

If this metal is silver, for example, that is, in polarized glass in which ellipsoidal silver particles are dispersed or arranged as the extended metal particles, the TM wave exhibits plasma resonance absorption in the visible light region on the long wavelength side of 380 nm, causing the transmission factor to decrease. Also in this case, the TE wave exhibits plasma resonance absorption in the region near 380 nm, and also increases the transmittance factor on the long wavelength side of visible light, particularly in the green region.

If the metal is copper, for example, i.e. in polarized glass in which ellipsoidal cooper particles are dispersed or arranged as the extended metal particles, the TM wave exhibits plasma resonance absorption in the visible light region on the long wavelength side of 570 nm, causing the transmission factor to decrease. Also in this case, the TE wave exhibits plasma resonance absorption in the region near 570 nm, which decreases the transmission factor.

As shown above, in comparison to polarized glass in which copper is dispersed or oriented, polarized glass in which silver is dispersed or oriented has a higher contrast ratio, which is the ratio between the transmission factors of the TE wave and the TM wave, on the long wavelength side of visible light, particularly the green region. Accordingly, in the polarized glass manufacturing method of the present embodiment, the glass base material formed in the preparation step desirably has silver particles dispersed therein. As a result, the ellipsoidal silver particles can be dispersed or oriented as the extended metal particles in the polarized glass formed by the manufacturing method described above.

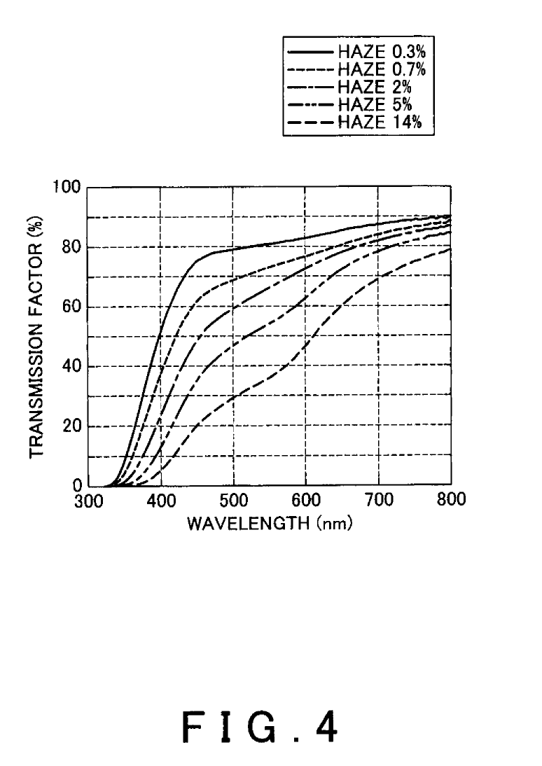

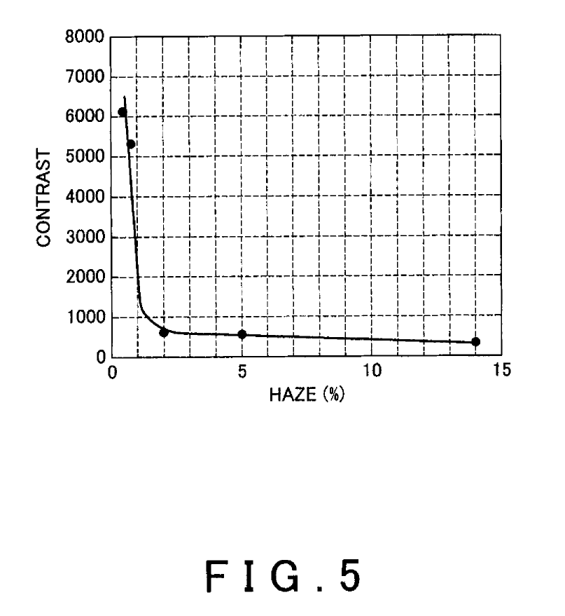

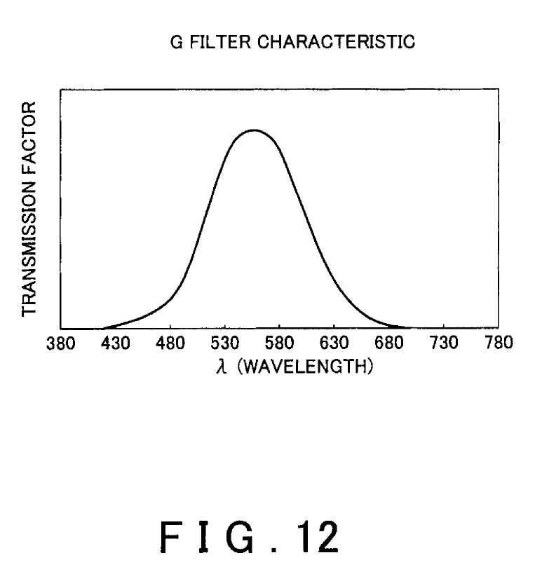

FIG. 4 is a graph showing a relationship between the transmission factor and wavelength region when non-polarized visible light passes through glass preforms 11 having various types of haze. FIG. 5 is a graph showing a relationship between the haze of the glass preform 11 and the contrast ratio of the polarized glass formed from the glass preform 11. The glass preforms 11 used to obtain the relationships shown in FIGS. 4 and 5 have a width of 2 mm and were formed by the steps of the manufacturing method of the present embodiment up until the deposition step. Here, the haze value of the glass preform 11 is represented by a percent of scattered light in the total light passed through the glass preform 11. In the present embodiment, this percentage was measured for light in the green wavelength region, as an example, in order to focus on the behavior of the visible light wavelength region of the polarized glass. More specifically, in the present embodiment, the haze value of the glass preform 11 was measured by shining light on the glass preform 11 from a halogen lamp, filtering the light passing through the glass preform 11 with a G filter, and receiving the filtered light with a photodetector. Here, the halogen lamp emits non-polarized light in a wavelength region from 360 nm to 3000 nm, which includes the wavelength region of visible light. As shown in FIG. 12, for example, the G filter has a maximum transmission factor in the wavelength region of green light, which is from 520 nm to 590 nm. The contrast ratio of the polarized glass shown in FIG. 5 is a contrast ratio with respect to visible light centered on the green region, i.e. the TE wave and the TM wave.

As shown in FIG. 4, the glass preform 11 has a higher transmission factor in the visible region when the haze is smaller. The transmission factor of the TE wave, which correlates with the contrast ratio in the polarized glass formed from the steps of extending and reducing the glass preform 11, is important. However, the TE wave transmission factor of the polarized glass is known to have a positive correlation with the transmission factor of the glass preform 11. Furthermore, due to a difference in thickness between the glass preform 11 and the polarized glass and differences in the shapes of the metal particles contained therein, the transmission factor of the glass preform 11 in the visible region is 10% to 30% lower than the TE wave transmission factor of the polarized glass. Therefore, in the manufacturing process of the present embodiment, it is desirable to form a glass preform 11 in the deposition step with a transmission factor greater than 60% to 70%, in order to manufacture polarized glass in which at least the TE wave transmission factor in the green region is greater than 75%. Accordingly, in the deposition step, it is desirable to form the glass preform 11 with a haze value that is less than approximately 1.5%.

As shown in FIG. 5, the contrast ratio of the polarized glass formed from the glass preform 11 increases when the haze of the glass preform 11 decreases. In particular, the contrast ratio of the polarized glass increases sharply when the haze of the glass preform 11 is less than approximately 2%. The haze of the glass preform 11 at which the contrast ratio of the polarized glass in the green region becomes greater than 1000:1 is less than approximately 1.3%. Therefore, in order to manufacture polarized glass in which the TE wave transmission factor in the green region is greater than 75% and the contrast ratio is greater than 1000:1, it is desirable that, in the deposition step, the glass preform 11 be formed to have haze that is less than approximately 1.3%.

Furthermore, the deposition step described above involves depositing the metal halide particles 30 in the glass base material, but the deposition of these metal halide particles 30 can be divided into separate stages for nucleation and for nuclear growth. That is, in the deposition step, the nuclei of the metal halide particles 30 in the glass base material are heated to a prescribed temperature for generation, i.e. a nucleation temperature, and then held at this temperature for a prescribed time, after which the nuclei of the metal halide particles 30 generated in the glass base material are heated to a temperature for growth, i.e. a nuclear growth temperature, and held at this temperature for a prescribed time. The conditions for the time and temperature of the nucleation and nuclear growth are greatly affected by the number and size of the metal halide particles 30 being deposited. In the manufacturing method according to the present embodiment, the nucleation temperature is desirably within a range of ±30 degrees Celsius from the deformation temperature of the glass base material. By holding the glass base material at this temperature for at least two hours, the nuclei of the metal halide particles 30 in the glass base material can be efficiently generated.

The nuclear growth temperature is desirably greater than the softening temperature of the glass base material since such a temperature accelerates nuclear growth. However, an increase in the nuclear growth temperature causes the haze of the glass preform 11 to increase sharply, causing the haze to be higher than necessary. If the nuclear growth temperature is significantly lower than the softening temperature of the glass base material, the nuclear growth is slower, and therefore this lower temperature is undesirable for manufacturing. Considering the above, it is desirable to hold the glass base material for a specified time that is less than five hours at a temperature that is between a temperature lower than the softening point of the glass base material by 20 degrees Celsius and a temperature that is 30 degrees Celsius higher than the softening point of the glass base material.

If the time and temperature for the nucleation and nuclear growth are in the above range, more metal halide particles 30 can be deposited during the deposition step to manufacture the glass preform 11 with a haze value no greater than 1.3%.

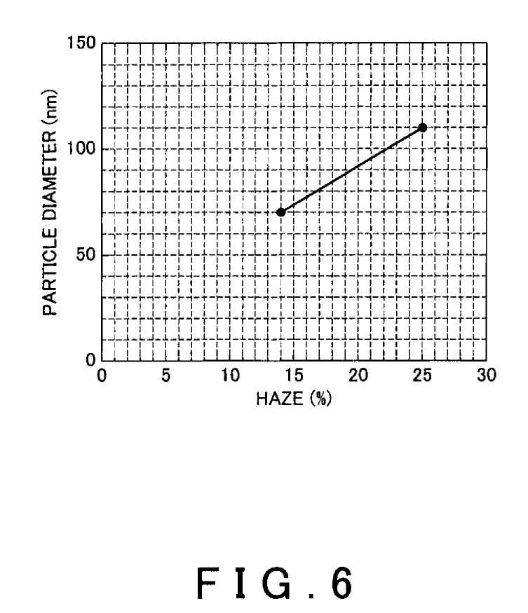

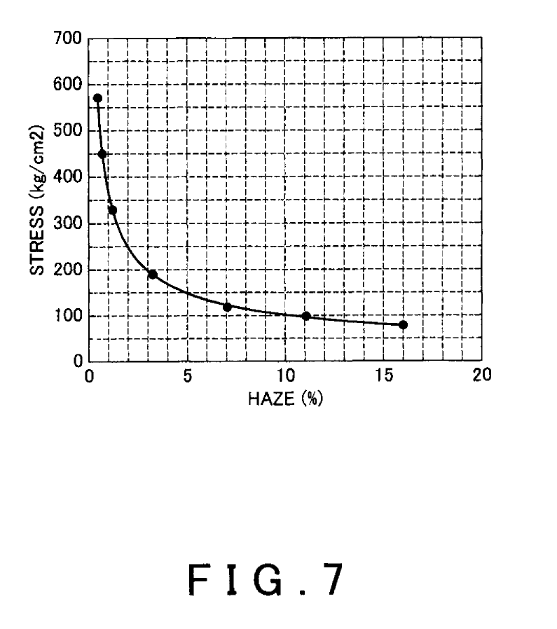

FIG. 6 is a graph showing the relationship between the haze of the glass preform 11 and the average diameter of the metal halide particles 30 in the glass preform 11. FIG. 7 is a graph showing the relationship between the haze of the glass preform 11 and the tensile stress exerted during the extension step on the polarized glass formed from the glass preform 11. In the graph of FIG. 7, the stress shown on the vertical axis is the tensile stress exerted on the glass preform 11 during the extension step to cause the wavelength of the TM wave exhibiting plasma resonance absorption in the polarized glass to be centered at 550 nm.

As shown in FIG. 6, the relationship is unknown for haze values under 15%, but smaller haze values correlate with smaller average diameters of the metal halide particles 30 contained in the glass preform 11. By extending the graph for haze values above 15% shown in FIG. 6 to predict the relationship for haze values below 15%, the average diameter of the metal halide particles 30 in the glass preform 11 having a haze value under 1.3% is less than 25 nm.

As shown in FIG. 7, smaller haze values cause an increase in the tensile stress exerted on the glass preform 11 during the extension step to give the polarized glass the above characteristics. The tensile stress is approximately 570 kg/cm² when the haze value is approximately 0.3%. The glass preform 11 formed by the above deposition step has an extremely high chance of breaking if extended with a tensile stress greater than 700 kg/cm², and so when considering the yield of the formed polarized glass, the practical limit for the tensile stress exerted on the glass preform 11 during the extension step is considered to be 600 kg/cm².

As shown in FIG. 7, larger haze values cause a decrease in the tensile stress exerted on the glass preform 11 during the extension step. The tensile stress is approximately 300 kg/cm² when the haze value is approximately 1.3%. Therefore, in order to manufacture polarized glass in which the TE wave transmission factor in the green region is above 75% and the contrast ratio is greater than 1000:1, it is desirable that the glass preform 11 be formed in the deposition step to have a haze value approximately between 0.3% and 1.3%, and that this glass preform 11 be extended with a tensile stress between 300 kg/cm² and 600 kg/cm², according to the haze, during the extension step.

Table 1 shows the affect that the reduction state used during the reduction step has on the transmission factor of the TE wave, the contrast ratio, and the bandwidth displaying plasma resonance absorption for the TM wave in the polarized glass.

TABLE 1

| REDUCTION | TRANSMISSION | CONTRAST | |
|---|---|---|---|
| STATE | FACTOR | RATIO | BANDWIDTH |
| STRONG | EXTREMELY | HIGH | SLIGHTLY |
| REDUCTION | LOW | | WIDE |
| WEAK | HIGH | SLIGHTLY | SLIGHTLY |
| REDUCTION | | LOW | NARROW |

In Table 1, the “strong reduction” refers to a reduction using a high temperature and a long time, and the “weak reduction” refers to a reduction using a low temperature and a short time. As shown by Table 1, when strong reduction is applied to the glass sheet 19 during the reduction step, the transmission factor becomes undesirably low. Accordingly, in order for the polarized glass to display superior polarization characteristics in the visible region, the weak reduction is applied to the glass sheet 19 during the reduction step with temperature and time selected to achieve a favorable contrast ratio and bandwidth in the reduction step. Here, if the temperature during reduction is higher than the transition temperature of the glass sheet 19, the extended metal particles reduced in the glass sheet 19 revert back to spheres, and so the contrast ratio decreases and the bandwidth narrows.

Accordingly, the temperature during the reduction is desirably lower than the transition temperature of the glass sheet 19. More specifically, the temperature during the reduction is desirably at least 20 degrees Celsius lower than the transition temperature of the glass sheet 19. By performing the reduction on the glass sheet 19 with the above time and temperature, the extended metal particles in the glass sheet 19 do not revert to spheres during the reduction, and so the reduction of the extended metal halide particles in the glass sheet 19 can proceed quickly. If the time duration of the reduction process is too short, the contrast ratio of the polarized glass decreases, but an excessively long time only increases the contrast ratio very slightly from a certain value. Accordingly, the time duration of the reduction process is desirably between 30 minutes and 4 hours, and more desirably between 2 and 3 hours. In the reduction step, if a combination of time and temperature is selected from the above ranges, the resulting polarized glass will have a high transmission factor, a high contrast ratio, a wide bandwidth, and superior optical characteristics.

In the polarized glass manufacturing method of the present embodiment, by applying a combination of the above conditions at each step from the preparation step to the reduction step, polarized glass can be manufactured to have, in a bandwidth from 500 nm to 800 nm, a transmission factor greater than 75%, a contrast ratio greater than 1000:1, and a bandwidth displaying these characteristics that is at least 100 nm. The glass melted in the preparation step has a transmission factor with a tendency to drop slightly, in order to show the photochromic characteristics in the visible region, but the photochromic characteristics can be suppressed by reducing the majority of the extended metal halide particles 32 into the extended metal particles during the reduction step, so that the manufactured polarized glass has favorable optical characteristics in the visible region.

Upon examining the relationship between (i) the haze occurring when the green region non-polarized light passes through the polarized glass manufactured via the above method and (ii) the same haze occurring in the glass preform 11 obtained when manufacturing this polarized glass, it was seen that when the haze of the glass preform 11 is 1.3%, the haze of the polarized glass obtained from this glass preform 11 is 2%. Furthermore, when the haze of the glass preform 11 was 0.6%, the haze of the polarized glass obtained from the glass preform 11 was 1%.

In order to manufacture polarized glass in which the TE wave transmission factor in the green region is above 75% and the contrast ratio is above 1000:1, as described above, the glass preform 11 is manufactured to have a haze between 0.3% and 1.3% during the deposition step. Accordingly, with consideration paid to individual differences as the characteristics of the polarized glass obtained from the glass preform 11, the haze is desirably always between 1% and 3%. It is even more desirable that the haze be between 1% and 2%.

The following describes an exemplary embodiment obtained from a conventional manufacturing method and an exemplary embodiment confirming the effects of the polarized glass manufacturing method shown above.

### First Embodiment

Glass raw material containing, by percentage weight, Li₂O: 1.8 wt %, Na₂O: 5.5 wt %, K₂O: 5.7 wt %, B₂O₃; 18.2 wt %, Al₂O₃: 6.2 wt %, SiO₂: 56.3 wt %, AG: 0.24 wt %, Cl: 0.16 wt %, Br: 0.16 wt %, CuO: 0.01 wt %, ZrO₂: 5.0 wt %, and TiO₂: 2.3 wt % was inserted into a platinum crucible and pre-melted at a temperature of approximately 1350 degrees Celsius. The glass resulting from this pre-melting was broken into candy-sized pieces and put back into the platinum crucible as cullet. Next, the main melting was performed at 1450 degrees Celsius, the melted material was poured into a graphite mold to be shaped, and was then placed in a lehr for annealing, resulting in the glass base material. The transition temperature of the glass base material was approximately 520 degrees Celsius, the deformation temperature was approximately 605 degrees Celsius, and the softening temperature was 700 degrees Celsius. The melting point of metal halide particles is approximately 450 degrees Celsius.

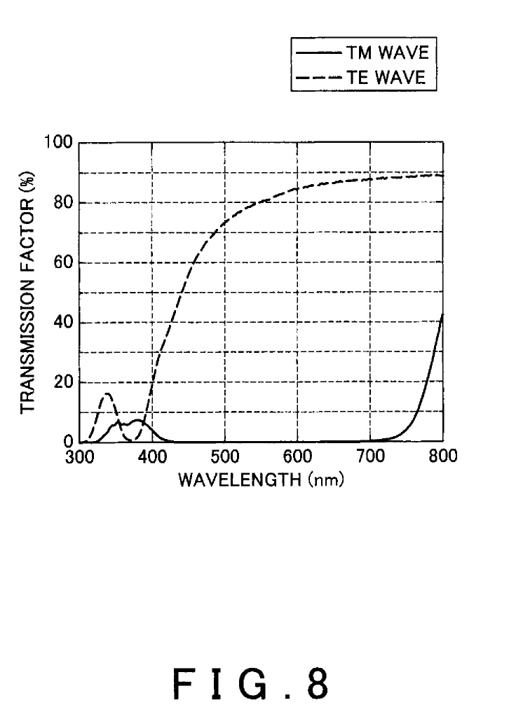

Next, during the deposition step, the glass base material underwent nucleation for three hours at 620 degrees Celsius, and then underwent nuclear growth for two hours at 690 degrees Celsius. The haze of the resulting glass was 0.8%. This glass base material was formed into an experimental preform with dimensions of 70 by 250 by 3 mm, for width, length, and thickness, respectively, and then subjected to the extension step. During the extension step, the preform was inserted into an electric furnace and heated such that the viscosity of the glass became between approximately 1×10¹⁰ and 1×10¹¹ poise. In this state, the preform was fed at a rate of 1.5 mm/minute. The preform was sandwiched between the two rollers that mechanically rotate in synchronization and a stress of approximately 500 kg/cm2 was applied while the preform was extended at a stretching rate of 35 mm/minute to form the glass sheet. This glass sheet was annealed for two hours at 480 degrees Celsius, severed and placed in a hydrogen atmosphere, and then subjected to the reduction step at 470 degrees Celsius for two and a half hours. The resulting polarized glass had a width of approximately 18 mm and a thickness of approximately 0.7 mm. Upon measuring the transmission factor characteristics of the polarized glass, the central wavelength (CWL) of the TM wave exhibiting plasma resonance absorption was found to be approximately 570 nm, as shown in FIG. 8. The transmission factor at the wavelength region from 500 nm to 600 nm was between 74% and 85%, with an average of 80%, the contrast ratio, i.e. the ratio of the TE wave (S wave) to the TM wave (P wave), was 5000:1, and the bandwidth was approximately 300 nm. An optical endurance test using an extra-high pressure mercury lamp, which is a so-called UHP test, is performed to continuously radiate the polarized glass for 24 hours with light having an illuminance of 3700 lumen in a wavelength region of 500 nm to 600 nm. After this, the transmission factor characteristic of the polarized glass was measured, and it was found that the absorption of the photochromic characteristics had not increased, and the transmission factor and the contrast ratio were the same as before the testing.

### Comparative Example 1

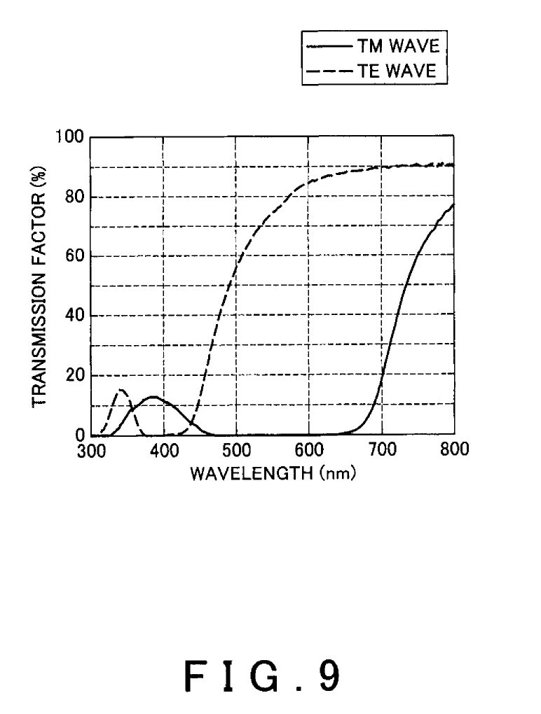

The glass base material used in the first embodiment above was subjected to heat processing that involved nucleation for one hour at 620 degrees Celsius followed by nuclear growth for four hours at 690 degrees Celsius. The resulting glass had haze of 1.4%. This glass was then formed as the same experimental preform used in the first embodiment, and the extension step was performed with a stress of 330 kg/cm² such that the CWL became 550 nm. After this, the annealing and reduction steps were performed with the same conditions as in the first embodiment to obtain polarized glass with a width of approximately 18 mm and a thickness of approximately 0.7 mm. Upon measuring the transmission factor characteristic of this polarized glass, it was found that the CWL was approximately 550 nm and the bandwidth was approximately 180 nm, as shown in FIG. 9. However, the transmission factor at the wavelength region from 500 nm to 600 nm was between 56% and 84%, with an average of 70%, and the contrast ratio, i.e. the ratio of the TE wave (S wave) to the TM wave (P wave), was less than 900:1. Both of these characteristics are lower than those of the polarized glass obtained in the first embodiment.

### Comparative Example 2

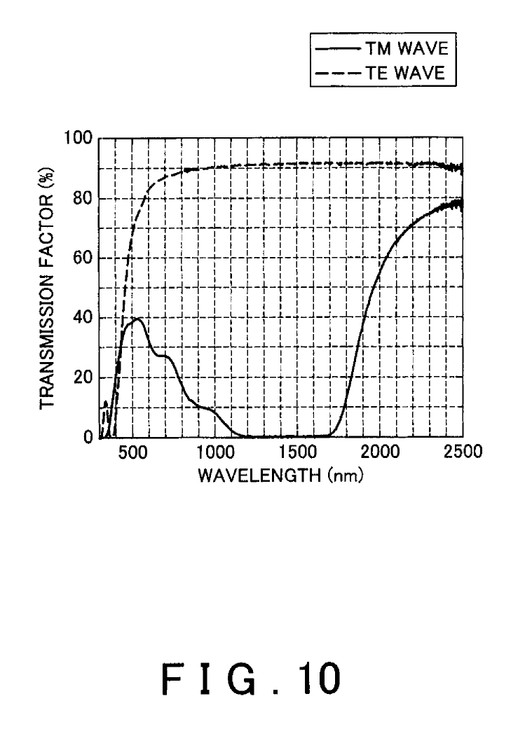

The glass base material used in the first embodiment above was subjected to heat processing that involved nucleation for three hours at 620 degrees Celsius followed by nuclear growth for four hours at 720 degrees Celsius. The resulting glass had haze of 7%. This glass was then formed as the same experimental preform used in the first embodiment, and the extension step was performed with a stress of 500 kg/cm². After this, the annealing and reduction steps were performed with the same conditions as in the first embodiment to obtain polarized glass with a width of approximately 18 mm and a thickness of approximately 0.7 mm. Upon measuring the transmission factor characteristic of this polarized glass, it was found that the CWL was approximately 1415 nm and the bandwidth was approximately 450 nm, as shown in FIG. 10. However, due to the CWL being 1415 nm, the transmission factor at the wavelength region from 500 nm to 600 nm was between 68% and 83%, with an average of 77%, and the contrast ratio, i.e. the ratio of the TE wave (S wave) to the TM wave (P wave), was less than 5:1.

### Comparative Example 3

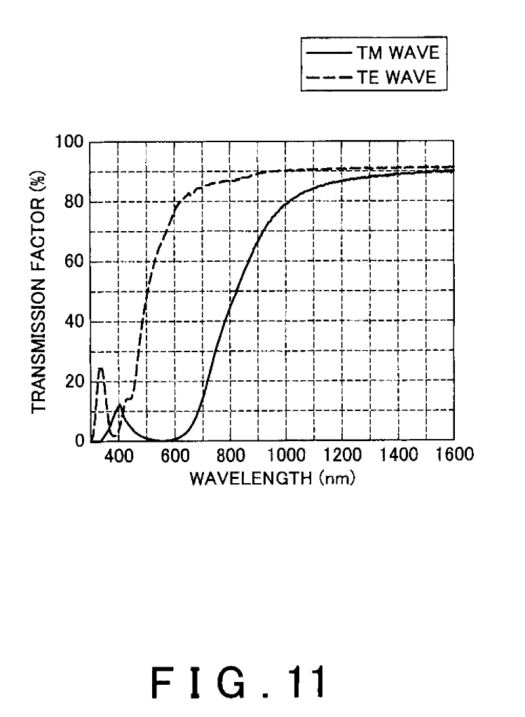

The glass base material used in the first embodiment above was subjected to the same deposition step used in Comparative Example 2. The resulting glass was then formed as the same experimental preform used in the first embodiment, and the extension step was performed with a stress of 120 kg/cm² such that the CWL became 550 nm. After this, the annealing and reduction steps were performed with the same conditions as in the first embodiment to obtain polarized glass with a width of approximately 18 mm and a thickness of approximately 0.7 mm. Upon measuring the transmission factor characteristic of this polarized glass, it was found that the CWL was approximately 550 nm and the bandwidth was approximately 80 nm, as shown in FIG. 11. The transmission factor at the wavelength region from 500 nm to 600 nm was between 49% and 77%, with an average of 65%, and, since the transmission factor was low and the a portion of the range from 500 nm to 600 nm was outside of the wavelength band displaying plasma resonance absorption of the TM wave, the contrast ratio, i.e. the ratio of the TE wave (S wave) to the TM wave (P wave), was less than 600:1.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A method for manufacturing polarized glass, comprising:
forming a glass preform by melting glass that includes metal ions and halogen ions and then depositing metal halide particles in the glass in which the metal ions and the halogen ions are dispersed;
forming a glass sheet containing extended metal halide particles that are obtained by extending the metal halide particles by performing thermal drawing on the glass preform at a prescribed temperature;
annealing by heating the glass sheet to a temperature that is no greater than a transformation temperature of the glass and no less than a distortion temperature of the glass; and
reducing the extended metal halide particles in the glass sheet that has undergone said annealing into extended metal particles, wherein
the glass preform formed in said forming a glass preform has a haze between 0.3% and 1.3% with respect to light in a wavelength region passed by a G filter.

2. The method according to claim 1, wherein
the metal halide particles deposited during said forming a glass preform have diameters between 10 nm and 30 nm.

3. The method according to claim 2, wherein
during said forming a glass preform, the glass is held for at least two hours in a temperature range that is ±30 degrees Celsius from a deformation temperature the glass, and is then held for a prescribed time no longer than five hours in a temperature range between a temperature 20 degrees Celsius lower than a softening temperature of the glass and a temperature 30 degrees Celsius higher than the softening temperature of the glass.

4. The method according to claim 3, wherein
during said reducing, the glass sheet is held for a prescribed time between 30 minutes and 4 hours at a temperature that is 20 degrees Celsius or more lower than a transition temperature of the glass.

5. The method according to claim 4, wherein
during said reducing, the extended metal particles reduced from the extended metal halide particles in the glass sheet include silver.

6. The method according to claim 1, wherein
during said forming a glass preform, the glass is held for at least two hours in a temperature range that is ±30 degrees Celsius from a deformation temperature the glass, and is then held for a prescribed time no longer than five hours in a temperature range between a temperature 20 degrees Celsius lower than a softening temperature of the glass and a temperature 30 degrees Celsius higher than the softening temperature of the glass.

7. The method according to claim 6, wherein
during said reducing, the glass sheet is held for a prescribed time between 30 minutes and 4 hours at a temperature that is 20 degrees Celsius or more lower than a transition temperature of the glass.

8. The method according to claim 7, wherein
during said reducing, the extended metal particles reduced from the extended metal halide particles in the glass sheet include silver.

9. The method according to claim 1, wherein
during said reducing, the glass sheet is held for a prescribed time between 30 minutes and 4 hours at a temperature that is 20 degrees Celsius or more lower than a transition temperature of the glass.

10. The method according to claim 9, wherein
during said reducing, the extended metal particles reduced from the extended metal halide particles in the glass sheet include silver.

11. The method according to claim 1, wherein
during said reducing, the extended metal particles reduced from the extended metal halide particles in the glass sheet include silver.

12. Polarized glass manufactured via a method comprising:
forming a glass preform by melting glass that includes metal ions and halogen ions and then depositing metal halide particles in the glass in which the metal ions and the halogen ions are dispersed;
forming a glass sheet containing extended metal halide particles that are obtained by extending the metal halide particles by performing thermal drawing on the glass preform at a prescribed temperature;
annealing by heating the glass sheet to a temperature that is no greater than a transformation temperature of the glass and no less than a distortion temperature of the glass; and
reducing the extended metal halide particles in the glass sheet that has undergone said annealing into extended metal particles, wherein
the glass preform formed in said forming a glass preform has a haze between 0.3% and 1.3% with respect to light in a wavelength region passed by a G filter.

13. The polarized glass according to claim 6, wherein
the haze with respect to light in a wavelength region passed by the G filter is between 1% and 3%.
